(19) United States
(12) Patent Application Publication
(10) Pub. No.: US 2011/0011046 A1
(43) Pub. Date: Jan. 20, 2011

(54) DISCHARGE DIVERTER FOR LAWNMOWER AND SIMILAR LAWN CARE APPARATUS

(76) Inventor: Robert B. Byard, Akron, OH (US)

Correspondence Address: Emerson, Thomson & Bennett, LLC, 1914 Akron-Peninsula Road, Akron, OH, 44313, US

(21) Appl. No.: 12/836,109

(22) Filed: Jul. 14, 2010

Related U.S. Application Data
(60) Provisional application No. 61/225,277, filed on Jul. 14, 2009.

(51) Int. Cl. A01D 34/71

(52) U.S. Cl. 56/14.5

(57) ABSTRACT

An apparatus and method for the directing the discharge from an associated lawn mower includes an upper member operatively connected to the associated lawn mower, and having a first end for receiving the flow of material from the lawn mower, a bearing attached to the upper member and extending from an outer surface of the upper member, and a lower member rotatably connected to the upper member, the lower member having a channel near a first end for receiving the bearing, wherein the bearing slides along the channel as the lower member rotates relative to the upper member.

### CROSS-REFERENCE TO RELATED APPLICATIONS

This application claims the benefit of U.S. Provisional Application No. 61/225,277, titled DISCHARGE DIVERTER FOR LAWNMOWER AND SIMILAR LAWN CARE APPARATUS, filed Jul. 14, 2009, which is herein incorporated by reference.

### I. BACKGROUND OF THE INVENTION

A. Field of Invention

This invention pertains to devices for cutting a material and then directing the cut portions, such as cutting vegetation, such as with reapers or lawnmowers, and more specifically, to riding lawnmowers with side discharge shuts, such as are used to mow residential lawns, or to blow leaves to one side of such residential lawn.

B. Description of the Related Art

Mechanical devices for cutting vegetation are well known. On the larger scale, in the agricultural area, reapers and other harvesting equipment, to harvest vegetation, such as wheat and the like, are well known. In some cases, a shearing device cuts the vegetation while a processing device bundles it or otherwise disposes or moves it. In the lawn care business, it is well known to have lawnmowers. Over the past years, lawnmowers became more sophisticated to where, rather than simply cutting and discharging grass clippings, grass clippings are now sometimes mulched and other times collected into bags. Depending on the type of vegetation, the length, and the preference of the homeowner, each of these different processing steps (cutting and discharging, cutting and mulching, cutting and bagging) are all desirable. In addition, sometimes a residential lawnmower is also used to blow leaves from one side of a lawn to the other, as opposed to raking them up. Sometimes the homeowner blows the leaves from a first side of the lawn to a second side, and then, when the leaves are concentrated, rakes them into a tarp or otherwise gathers them into bags for disposal.

In the case of cutting and discharging, the operator of the lawnmower generally cuts the lawn in a systematic pattern to ensure that every portion of the lawn is cut. This typically involves moving the lawnmower in a linear fashion back and forth over the lawn with a slight overlap, so that every “ribbon” of lawn is cut in a uniform manner and no areas of the lawn are left uncut. Since lawnmowers discharge on one lateral side, usually on the operator's right, the lawnmower operator leaves a trail of clippings in alternate ribbons, as the lawnmower moves back and forth across the lawn. Depending on the length of the vegetation, as well as the closeness of the cut, such an approach may result in a stripped pattern of clumps of discharge on alternating stripes. Further, in the case of blowing leaves, such an approach will not move the leaves to a single side of the lawn.

In some cases, this particular pattern is not desirable. Because of the fixed discharge on the lateral side of a mower, some operators mow the lawn in a spiral pattern, starting at the center and moving outward towards the perimeter. This pattern is designed to continue push the clippings to the exterior perimeter of the lawn, thereby leaving the lawn relatively clear of clippings. Such an approach may also be used in the fall, as a way to process and move leaves. Rather than raking the leaves manually, some operators use a lawn care device, such as the lawn mower or a leaf blower, to cut and blow leaves.

While the above methods are in operation and have some success, it is also true that the spiral pattern discussed above is often not desirable. One reason is that it fails to leave the lawn with the attractive, stripped appearance that many operators desire. In addition, depending on the shape of the lawn, sometimes such an approach is not preferable as, rather than having a true spiral, an amorphous outline is created, since the lawn itself has such an outline. Also, depending on the amount of the clippings, the lawnmower might not be able to continue to push row after row of clippings to the exterior borders of the lawn without clogging or bogging down.

If an operator does not want to leave a trail of clippings in alternate ribbons then the operator must only mow the lawn with the discharge pointed in the same direction. This results in either mowing forward and backward with the discharge always pointed in the same direction, or only mowing in one direction and turning the mower off on the return pass. Since the return pass is unproductive, this necessarily and undesirably increases mowing time.

The above description states some of the problems solved by the invention. It is desirable to have a lawnmowing apparatus with a selectively directionable discharge so that the lawn clippings can be discharged in an intended and desired direction.

### II. SUMMARY OF THE INVENTION

According to one embodiment of this invention, a discharge apparatus, for directing a flow of material from an associated lawn mower, includes: an upper member operatively connected to the associated lawn mower, the upper member having a first end for receiving the flow of material from the lawn mower; a bearing attached to the upper member and extending from an outer surface of the upper member; and a lower member rotatably connected to the upper member, the lower member having a channel near a first end for receiving the bearing, wherein the bearing slides along the channel as the lower member rotates relative to the upper member. The discharge apparatus may also include an outlet member operatively connected to a second end of the lower member, the outlet member formed substantially of rubber, wherein the outlet member directs the flow of material in a substantially horizontal direction. The discharge apparatus may also include a handle for rotating the lower member, the handle operatively connected to an outer surface of the lower member, wherein the handle partially encircles the upper member. The discharge apparatus may also include an electric motor operatively connected to the lower member for rotating the lower member. The discharge apparatus may also include a first stop member for limiting rotation of the lower member in a first direction, and a second stop member for limiting rotation of the lower member in a second direction, wherein the lower member rotates through approximately 180 degrees.

According to another embodiment of this invention, a lawn mower includes: a mower deck having a cutting blade and a discharge chute; a discharge tube having a first end operatively connected to the discharge chute on the mower deck; and a discharge diverter including: an upper diverter member operatively attached to the lawn mower, the upper diverter member having a first end operatively connected to a second end of the discharge tube; a bearing attached to an outer surface of the upper diverter member; and a lower diverter member rotatably connected to the upper diverter member, the lower diverter member having a channel near a first end for receiving the bearing, the channel extending around a circumference of the lower member, wherein a portion of a second end of the upper diverter member is located within the first end of the lower diverter member. The lawn mower may also include an outlet member operatively connected to a second end of the lower member, the outlet member formed substantially of rubber, wherein the outlet member directs the flow of material in a substantially horizontal direction to the ground surface. The lawn mower may also include a handle for rotating the lower diverter member, the handle operatively connected to an outer surface of the lower member, wherein the handle partially encircles the upper member. The lawn mower may also include an electric motor operatively connected to the lower member for rotating the lower member. The lawn mower may also include a first stop member for limiting rotation of the lower member in a first direction, and a second stop member for limiting rotation of the lower member in a second direction, wherein the lower member rotates through approximately 180 degrees.

One advantage of this invention is that the flow of material from lawn mower can be selectively discharged in a variety of different direction. Another advantage of the invention is that is can be retrofitted to existing lawnmowers or can be included as original equipment by the lawn mower manufacturer.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a discharge diverter installed on a lawn mower;

FIG. 2 is a rear perspective view of a discharge diverter installed on a lawn mower;

FIG. 3 is a side perspective view of a discharge diverter installed on a lawn mower;

FIG. 4 is a perspective view of a discharge diverter according to one embodiment;

FIG. 5 is a side perspective view of the discharge diverter of FIG. 4 rotated counter-clockwise to engage the right stop member;

FIG. 6 is a side perspective view of the discharge diverter of FIG. 4 rotated clockwise to engage the left stop member;

FIG. 7 is a perspective view of the discharge diverter including a deflector;

FIG. 8 is a perspective view of the discharge diverter including a screen;

FIG. 9 is a cross-sectional view of the rotatable coupling shown in FIG. 4;

FIG. 10 is a perspective view of the rotatable coupling including an electric motor;

FIG. 11a is a diagram of the discharge diverter in operation, according to one embodiment; and

FIG. 11b is a diagram of the discharge diverter in operation, according to another embodiment.

### IV. DETAILED DESCRIPTION OF THE INVENTION

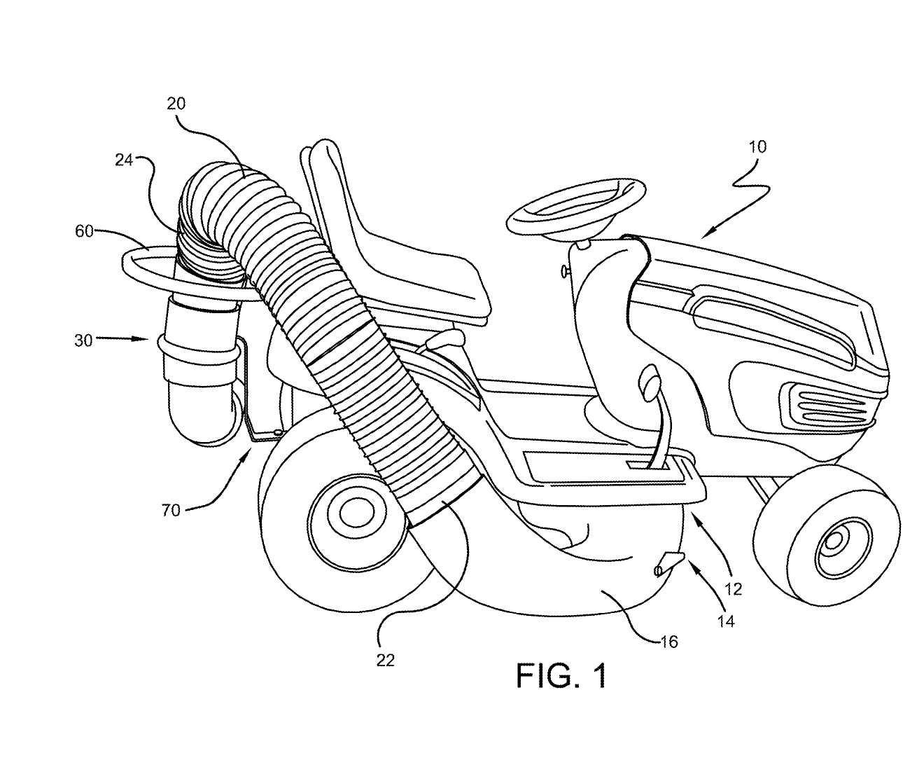

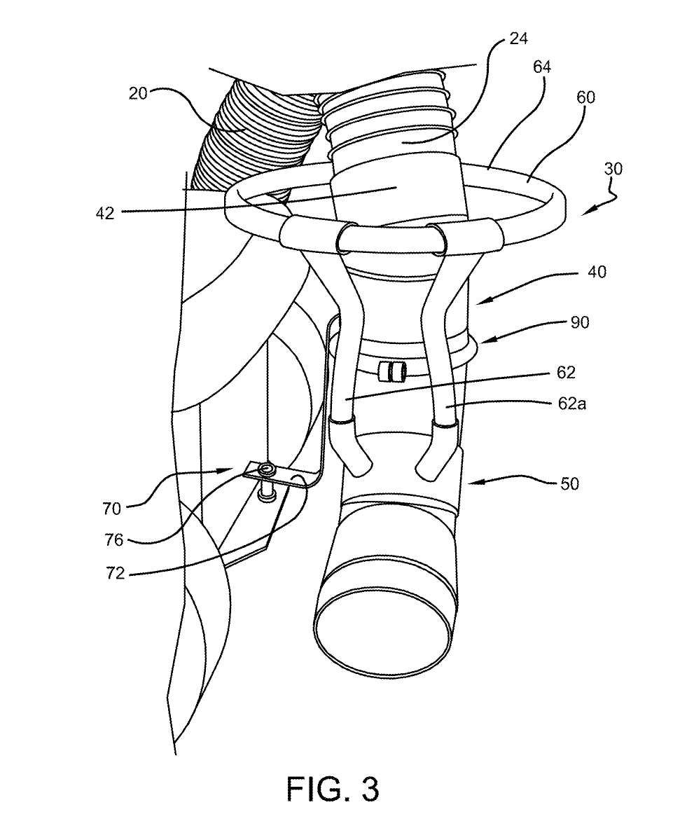

Referring to the drawings wherein the showings are for purposes of illustrating embodiments of the invention only and not for purposes of limiting the same, and wherein like reference numerals are understood to refer to like components, FIG. 1 shows a lawn mower 10 equipped with a discharge diverter 30 according to one embodiment of this invention. While the lawn mower 10 shown in FIG. 1 is a riding lawn mower, it is to be understood that the discharge diverter 30 will work with many vehicles including, for some non-limiting examples, lawn tractors, garden tractors, riding tractors, zero turn riding mowers, leaf blowers, and walk-behind mowers. The lawn mower 10 may have a mower deck 12, a mower discharge 14, and a collector 16. A collector tube 20 has a first end 22 operatively connected to the collector 16, and a second end 24 operatively connected to the discharge diverter 30. The collector 16 is sized to fit the mower discharge 14 of the mower deck 12. The diverter 30 is mounted on the mower 10 to provide an appropriate amount of ground clearance, as shown in FIGS. 1-3.

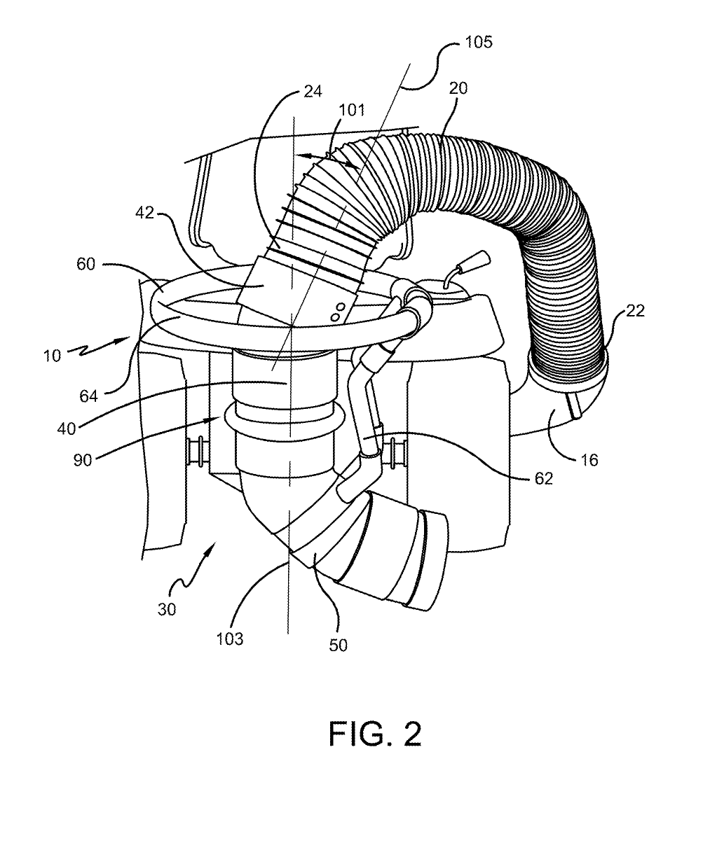

With reference now to FIGS. 1-6, the diverter 30 may be formed of schedule 40 polyvinylchloride (PVC), High Density Polyethylene (HDPE), due to its strength and moldability characteristics, or any other material chosen by one with ordinary skill in the art. In one embodiment, the discharge diverter 30 is made of PVC pipe. In a more specific embodiment, the discharge diverter 30 is made of approximately six-inch diameter PVC pipe. The diverter 30 may have an upper member 40, a lower member 50, a handle 60, an attachment mechanism 70, a discharge outlet section 80, and a rotatable coupling 90. The upper member 40 and the lower member 50 may be substantially tubular. The upper member 40 may have a first end 42, which can be biased or tilted toward the right side, from the operator's perspective, of the mower 10 when installed, as shown in FIG. 2. With continuing reference to FIG. 2, the bias or tilt of the first end 42 can be graphically seen by the intersection of the centerline 105 of the first end 42 and the centerline 103 of the upper member 40. The intersection of centerlines 103 and 105 creates an angle 101, which can be between 0 degrees and 90 degrees. In the embodiment shown, the angle 101 is about 30 degrees. Because lawn tractors made in the United States have the mower discharge 14 from the mower deck 12 on the right side of the lawn mower 10, the bias or tilt on the first end 42 of the upper member 40 of the diverter 30 to the right more easily facilitates the effective flow of material through the collector tube 20 and discharge diverter 30. The upper member 40 receives the second end 24 of the collector tube 20. The second end 24 of the collector tube 20 may fit inside the first end 42 of the upper member 40 with a friction fit.

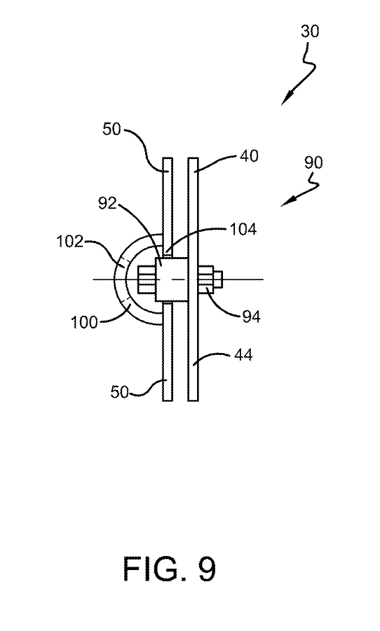

With continuing reference to FIGS. 1-6, the lower member 50 is rotatably connected to the upper member 40. A second end 44 of the upper member 40 fits inside a first end 51 of the lower member 50, as shown in FIG. 9. This layout allows material to flow from the upper member 40 to the lower member 50 without being caught or trapped in the rotatable coupling 90. The lower member 50 may have an upper section 54, which may be substantially vertical, a transition section 55, which may be a 45° elbow, and a lower section 56, which may be at approximately a 45° angle to vertical. The diverter 30 may include a channel 100, which may extend at least partially around the circumference of the lower member 50. In one embodiment, the channel 100 extends around substantially the entire circumference of the lower member 50. In another embodiment, the channel 100 extends around substantially the entire circumference of the upper section 54 of the lower member 50. The channel 100 may form a continuous portion of the upper section 54 or may be a separate piece attached to two separate pieces of the upper section 54. The channel 100 may include an opening 102 for accessing or cleaning a rotatable coupling 90 (discussed later herein). The lower member 50 may include a stop member 58, which extends from the outer surface of the lower member 50. The stop member 58 limits the rotation of the lower member 50. The stop member 58 is attached to the lower member 50 by a mechanical fastener or adhesive. The stop member 50 can be formed of any rigid material, including, but limited to, metal, plastic, rubber, or any combination of these materials. In one embodiment, the stop member 58 is a bolt, which extends from the outer surface of the lower member 50. In another embodiment, the stop member 58 is substantially formed of plastic or rubber with an end portion 59 formed of metal, such as steel. The lower member 50 may have two stop members 58, 58a positioned to allow the lower member 50 to rotate through approximately 180° . Each stop member 58 may limit rotation by engaging the attachment mechanism 70, described below in more detail.

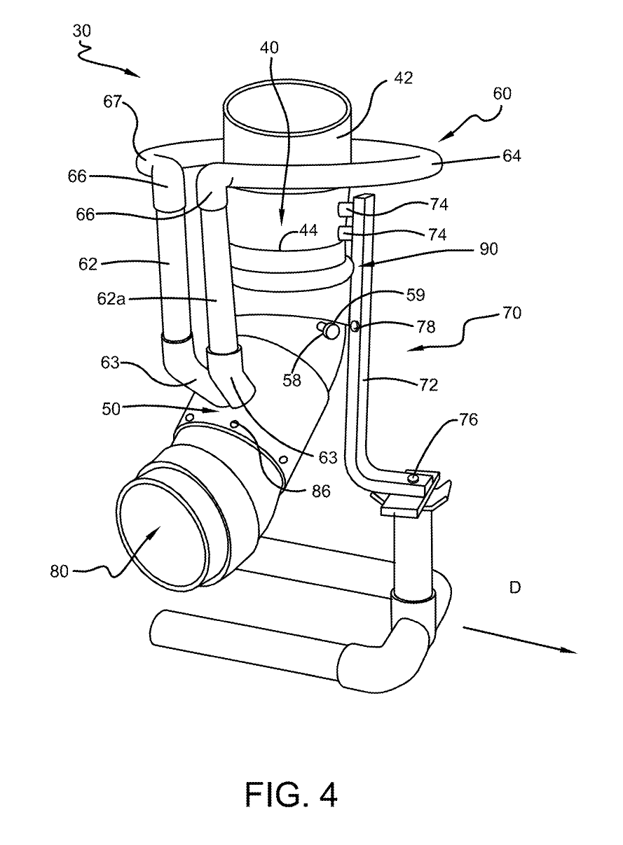

With continuing reference to FIGS. 1-6, the handle 60 may include a vertical portion 62 and an arcuate portion 64. The vertical portion 62 may have a first end 63 attached to the diverter 30 by bolts, screws, rivets, adhesive, or any other attachment means chosen by one with ordinary skill in the art. In one embodiment, the vertical portion 62 is attached to the lower section 56 of the lower member 50. The vertical portion 62 may have a second end 66 attached to the arcuate portion 64. The arcuate portion 64 may partially or substantially encircle the diverter 30. The handle 60 may be formed of PVC, HDPE, or any other material chosen by one with ordinary skill in the art. The handle 60 may include two vertical portions 62, 62a, in which the second end 66 of each vertical portion 62 attaches to an end 67 of the arcuate portion 64, as shown in FIG. 4. In one embodiment, the arcuate portion 64 of the handle 60 partially encircles the diverter 30 and has a diameter between approximately 10 and approximately 30 inches. In a more specific embodiment, the arcuate portion 64 is generally circular and has a diameter between approximately 14 and approximately 18 inches. One embodiment of the handle 60 is made of two inch (2″) diameter PVC pipe which has been bent to the nearly circular shape as illustrated in the FIGURES.

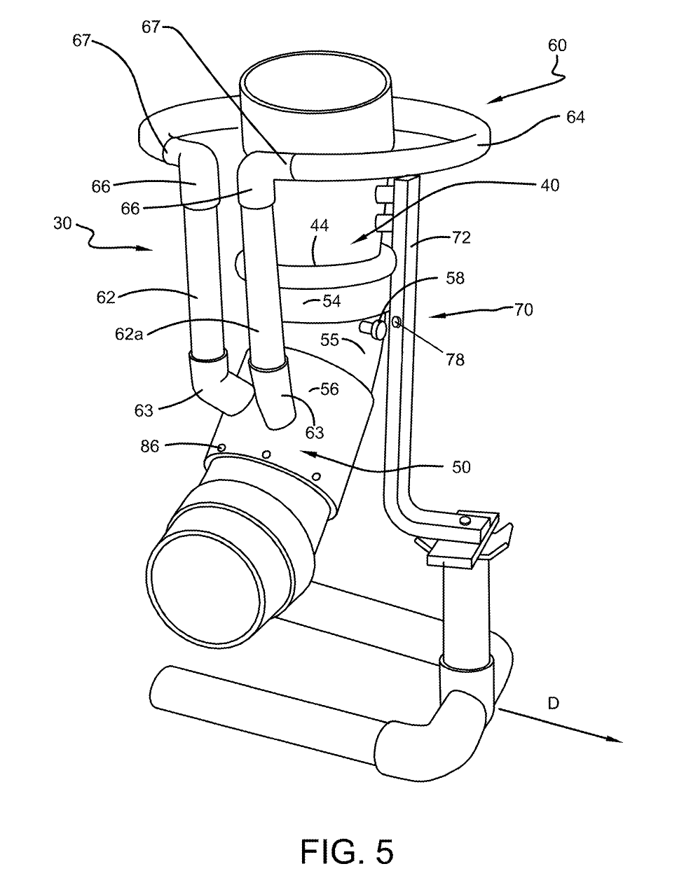

With continuing reference to FIGS. 1-6, the attachment mechanism 70 may include a bracket 72 attached to the diverter 30 by bolts, screws, rivets, adhesive, metal band, or any other attachment means 74 chosen by one with ordinary skill in the art. In one embodiment, the bracket 72 is attached to the upper member 40 with a bolt 74. The bracket 72 can be formed of metal, plastic, or other rigid material chosen by one with ordinary skill in the art. The bracket 72 may attach to the mower 10 by bolts, screws, rivets, adhesive, or any other attachment means 76 chosen by one with ordinary skill in the art. In one embodiment, the bracket 72 is made in a U-shaped cross-section to improve strength. A stop member 58 may contact the bracket 72 to limit rotation of the lower member 50. The lower member 50 may have a stop member 58, which contacts the bracket 72 when the diverter 30 is rotated in the counter-clockwise direction, or to the right, and another stop member 58a contacts the bracket 72 when the diverter 30 is rotated in the clockwise direction, or the left. The bracket 72 may include a securement mechanism at each location where a stop member 58 contacts the bracket 72. The securement mechanism could be hook and loop strips, adhesive, a hook and eye, a magnet, or any securement mechanism chosen with sound engineering judgment. One securement mechanism is a magnet 78. The magnet 78 may maintain the contact between the stop member 58 and the attachment mechanism until the user repositions the diverter 30. Each magnet may secure the rotational displacement of the discharge diverter in a preferred position 90° relative to the directional travel of the tractor 10. FIG. 5 shows an embodiment where the stop member 58 is in contact with the magnet 78, and the diverter 30 is in a right-most position at approximately 90° relative to the direction of travel D of the mower 10. FIGS. 6 shows an embodiment where the stop member 58 is in contact with the magnet 78, and the diverter 30 is in a left-most position at approximately 90° relative to the direction of travel D of the mower 10. The strength of the magnet 78 should be chosen so that it is strong enough to prevent unintended rotation of the lower member 50 but not so strong as to prevent desired rotation of the lower member 50 by the manually-generated forces of the operator.

With reference now to FIGS. 1-8, the discharge outlet section 80 may re-direct the flow of material, including lawn clippings, after the material exits the lower member 50 of the diverter 30. The discharge outlet section 80 may be formed of any resilient or flexible material chosen by one with ordinary skill in the art. The resiliently deformable material allows the discharge outlet section 80 to drag on the ground or contact obstacles without damage. In one embodiment, the discharge outlet section 80 is formed of ethylene propylene diene M-class rubber (EPDM rubber). In a more specific embodiment, the discharge outlet section 80 is an EPDM rubber 45° elbow, such as might also be used as an exhaust for a semi-tractor. The discharge outlet section 80 is attached to the lower member 50 of the diverter 30 by bolts, screws, rivets, adhesive, or any other attachment means 86 chosen by one with ordinary skill in the art. In one embodiment, the discharge outlet section 80 fits inside the lower member 50 and is attached by rivets.

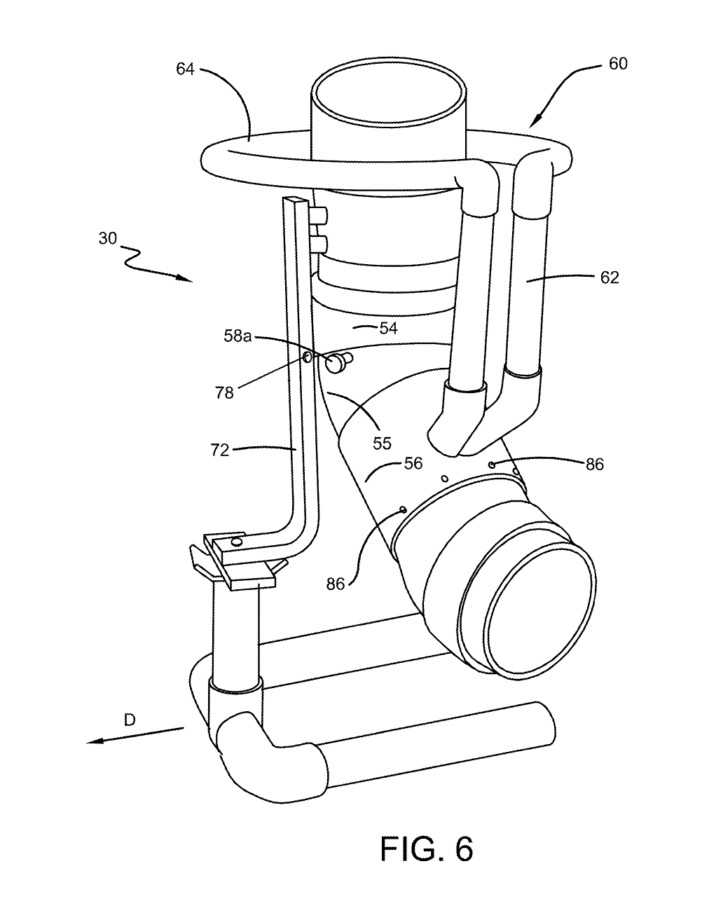

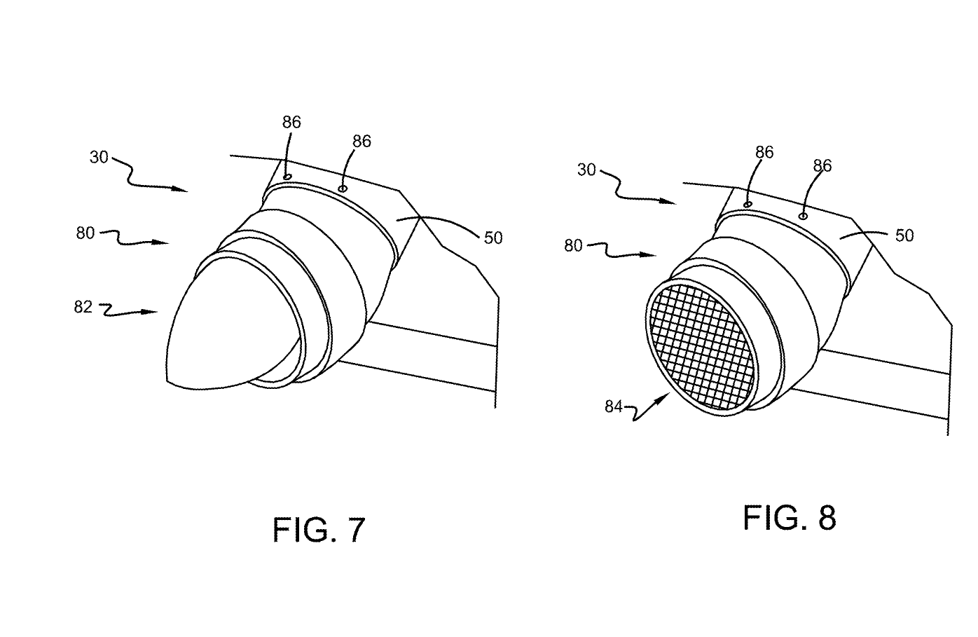

With reference now to FIG. 7, the diverter 30 may include a deflector 82. Because of safety considerations, or other design considerations, a hooded deflector 82 may be added to the diverter 30. In one embodiment, the upper half of the discharge outlet section 80 could be hooded or shielded by the deflector 82. The discharge outlet section 80 and the deflector 84 may be a single piece or separate pieces. With reference now to FIG. 8, the diverter 30 may include a screen 84 attached to the discharge outlet section 80 to prevent large objects or debris from being thrown from the diverter 30.

With reference now to FIG. 9, the rotatable coupling 90 may include a bushing or bearing 92 attached to the upper member 40 with a bolt, screw, rivet, other mechanical fastener, adhesive, or any other attachment means 94 chosen by one with ordinary skill in the art. The rotatable coupling might also be attached to the lower member 50, rather than to the upper member 40, or even in yet another way. The important thing is that the upper member 40 and the lower member 50 may rotate relative to one another, and in this embodiment, through the use of the externally mounted rotatable coupling 90. The bearing 92 may be substantially cylindrical. The bearing 92 may be formed of nylon, HDPE, polytetrafluoroethylene (PTFE) also known as Teflon®, or any other low friction plastic. The bearing 92 may also be formed of a rigid material having a low friction coating, such as a metal with a PTFE (Teflon®) coating. The channel 100 of the lower member 50 receives the bearing 92. The bearing 92 supports the lower member 50 and maintains the vertical position of the lower member 50 relative to the upper member 40. The channel 100 may include a top portion 104, which engages the bearing 92 and slides along the bearing 92 as the lower member 50 rotates. The rotatable coupling 90 may include a plurality of bearings 92, and in one embodiment, the rotatable coupling 90 includes six bearings 92 substantially evenly spaced around the circumference of the upper member 40.

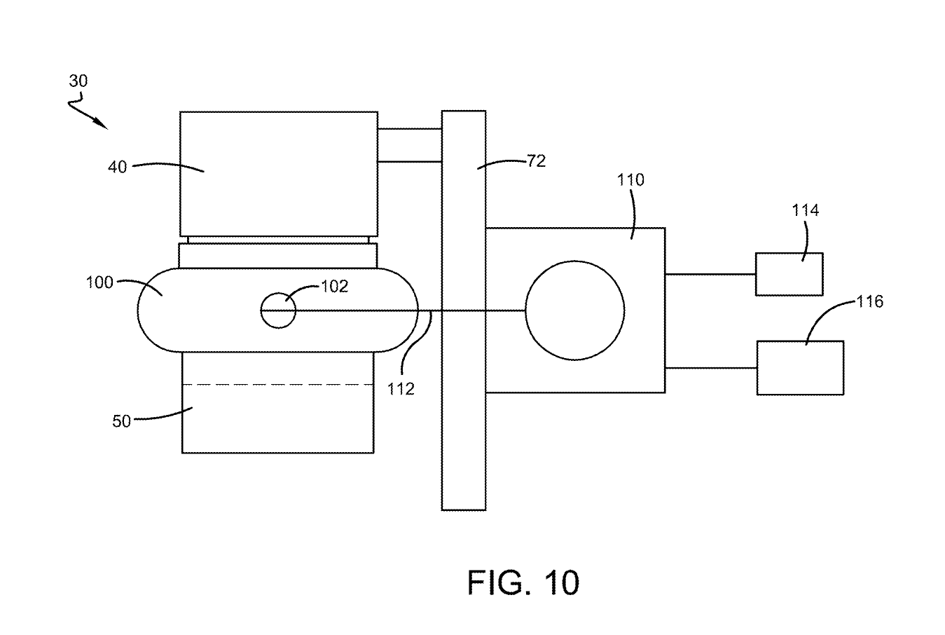

With reference now to FIG. 10, the diverter 30 may include a motor 110, instead of the handle or in addition to the handle, for rotating the lower member 50. In one embodiment, the motor 110 is an automotive window electric motor, as is well known in the art. The motor 110 may include a cable 112, which is operatively attached to the diverter 30. In one embodiment, the cable 112 is attached within the channel 100. The cable 112 may be attached by screws, bolts, rivets, or other mechanical fasteners. In another embodiment, the cable 112 wraps around the diverter so both end the cable 112 are connected to the motor 110. The motor 110 may include two cables 112, 112, where one cable 112 rotates the diverter 30 in a clockwise direction and the second cable 112 rotates the diverter in a counter-clockwise direction. The motor 110 may be attached to the diverter 30 by any means chosen by one with ordinary skill in the art. The motor 110 may be attached to the bracket 72 or the upper member 40. The motor 110 may include a rocker switch 114, which can be activated to rotate the diverter 30 either clockwise or counter-clockwise, and the motor will run until the diverter 30 has reached a right-most position, as shown in FIG. 5, or a left-most position, as shown in FIG. 6. The rocker switch 114 may be mounted on the mower, at any location chosen by one with ordinary skill in the art. In one embodiment, the rocker switch 114 is removably mounted on the mower. In a more specific embodiment, the rocker switch 114 fits into a cup-holder on the mower for easy installation and removal. The motor 110 may be operatively connected to a power source 116 provided by the mower or to a separate power source. In another embodiment, the motor 110 is a small electric stepping motor which rotates the upper or lower members 40, 50 via teeth cut into the upper or lower members 40, 50. In either case, the motor 110 could be wirelessly controlled.

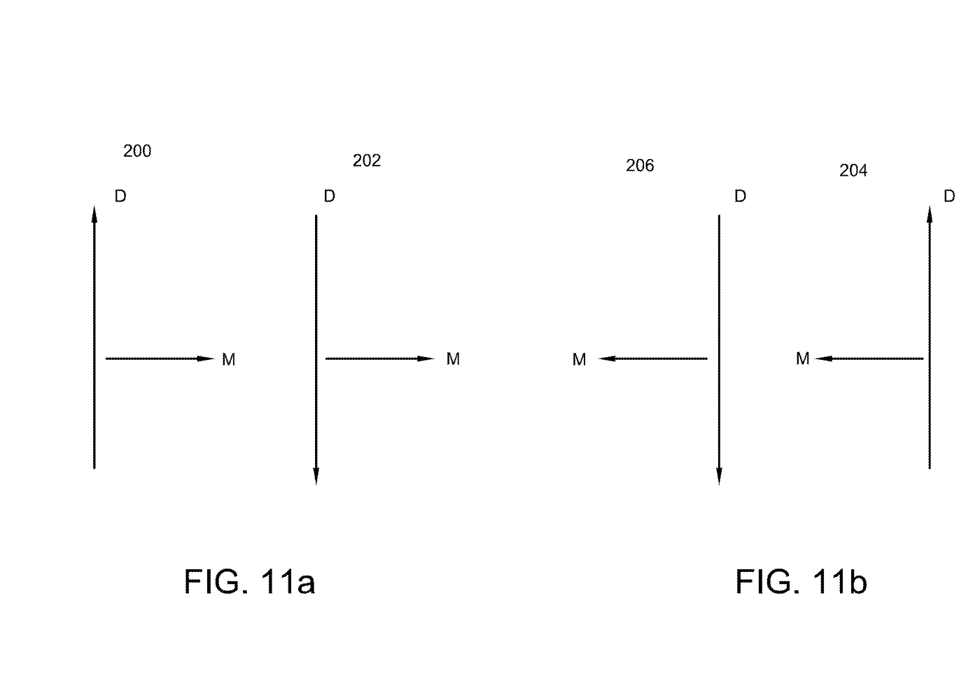

With reference now to all the FIGURES, the operation of the diverter will now be described. In one embodiment of the operation, the mower cuts the lawn from left to right, as shown in FIG. 11a. In this embodiment, the mower makes a first pass 200 by traveling in a direction D while the discharge diverter 30 discharges material or debris in a direction M, to the right of and approximately 90° to the direction of travel D. The mower then makes a second pass by traveling in a direction D while the discharge diverter 30 discharges material or debris in a direction M, to the left of and approximately 90° to the direction of travel D. Between the first pass 200 and the second pass 202, the discharge diverter 30 is rotated approximately 180° . The mower may continue alternating the first pass 200 and second pass 202 until all the lawn is cut or mowed. In another embodiment of the operation, the mower cuts the lawn from right to left, as shown in FIG. 11b. In this second embodiment, the mower makes a first pass 204 by traveling in a direction D while the discharge diverter 30 discharges material or debris in a direction M, to the left of and approximately 90° to the direction of travel D. The mower then makes a second pass 206 by traveling in a direction D while the discharge diverter 30 discharges material or debris in a direction M, to the right of and approximately 90° to the direction of travel D. Between the first pass 204 and the second pass 206, the discharge diverter 30 is rotated approximately 180° . The mower may continue alternating the first pass 204 and second pass 206 until all the lawn is cut or mowed.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1. A discharge apparatus for directing a flow of material from an associated lawn mower, the discharge apparatus comprising:
an upper member operatively connected to the associated lawn mower, the upper member having a first end for receiving the flow of material from the lawn mower;
a bearing attached to the upper member and extending from an outer surface of the upper member; and
a lower member rotatably connected to the upper member, the lower member having a channel near a first end for receiving the bearing;
wherein the bearing slides along the channel as the lower member rotates relative to the upper member.

2. The discharge apparatus of claim 1, wherein the upper member is substantially tubular, and wherein the lower member is substantially tubular.

3. The discharge apparatus of claim 1, further comprising:
an outlet member operatively connected to a second end of the lower member, the outlet member formed substantially of rubber, wherein the outlet member directs the flow of material in a substantially horizontal direction.

4. The discharge apparatus of claim 1, further comprising:
a deflector operatively connected to the lower member for directing the flow of material exiting the second end of the lower member at least partially towards a ground surface.

5. The discharge apparatus of claim 1, further comprising:
a screen operatively connected near the second end of the lower member and at least partially covering the second end of the lower member.

6. The discharge apparatus of claim 1, further comprising:
a handle for rotating the lower member, the handle operatively connected to an outer surface of the lower member;

7. The discharge apparatus of claim 6, wherein the handle partially encircles the upper member.

8. The discharge apparatus of claim 1, wherein the channel is substantially curvilinear.

9. The discharge apparatus of claim 1, further comprising:
an electric motor operatively connected to the lower member for rotating the lower member.

10. The discharge apparatus of claim 1, further comprising:
a first stop member for limiting rotation of the lower member in a first direction; and
a second stop member for limiting rotation of the lower member in a second direction;
wherein the lower member rotates through approximately 180 degrees.

11. A lawn mower comprising:
a mower deck having a cutting blade and a discharge chute;
a discharge tube having a first end operatively connected to the discharge chute on the mower deck; and
a discharge diverter comprising:
an upper diverter member operatively attached to the lawn mower, the upper diverter member having a first end operatively connected to a second end of the discharge tube;
a bearing attached to an outer surface of the upper diverter member; and
a lower diverter member rotatably connected to the upper diverter member, the lower diverter member having a channel near a first end for receiving the bearing, the channel extending around a circumference of the lower member, wherein a portion of a second end of the upper diverter member is located within the first end of the lower diverter member.

12. The lawn mower of claim 11, wherein the upper diverter member is substantially tubular, and wherein the lower diverter member is substantially tubular.

13. The lawn mower of claim 11, further comprising:
an outlet member operatively connected to a second end of the lower member, the outlet member formed substantially of rubber, wherein the outlet member directs the flow of material in a substantially horizontal direction to the ground surface.

14. The lawn mower of claim 11, further comprising:
a handle for rotating the lower diverter member, the handle operatively connected to an outer surface of the lower member, wherein the handle partially encircles the upper member.

15. The lawn mower of claim 11, wherein the channel is substantially arcuate.

16. The lawn mower of claim 11, further comprising:
an electric motor operatively connected to the lower member for rotating the lower member.

17. The lawn mower of claim 11, further comprising:
a first stop member for limiting rotation of the lower member in a first direction; and
a second stop member for limiting rotation of the lower member in a second direction;
wherein the lower member rotates through approximately 180 degrees.

18. A method of mowing a lawn comprising:
providing a discharge diverter for directing material received from a mower deck of the lawn mower; the discharge diverter operatively connected to the lawn mower;
mowing the lawn in a first mowing direction with the discharge diverter pointed in a first discharge direction approximately 90° to the direction of travel;
mowing the lawn in a second mowing direction, approximately 180° from the first mowing direction, with the discharge diverter pointed in a second discharge direction approximately 90° to the direction of travel and approximately 180° from the first discharge direction.

19. The method of claim 18, wherein the first discharge direction and the second discharge direction are towards un-mowed grass.

20. The method of claim 18, wherein the first discharge direction and the second discharge direction are towards mowed grass.

21. A discharge apparatus for directing a flow of material from an associated lawn mower, the discharge apparatus which can selectively discharge associated lawn clippings from a right side of the associated lawn mower or a left side of the associated lawn mower.

22. The discharge apparatus of claim 21 further comprising:
An outlet, the outlet selectively moveable from a first position discharging associated lawn clippings to the right side of an associated lawn mower to a second position discharging associated lawn clippings to the left side of an associated lawn mower.

23. The discharge apparatus of claim 22 wherein the outlet is selectively moveable between the first and second positions by manually-generated forces of an associated operator of the associated lawn mower.
